(19) United States
(12) Patent Application Publication
(10) Pub. No.: US 2024/0415158 A1
(43) Pub. Date: Dec. 19, 2024

(54) MICRONIZED COMPOSITIONS FOR IMPROVING HEALTHY DIETS, IMMUNE SYSTEMS, AND/OR JOINT HEALTH OF SUBJECTS, METHODS FOR PRODUCING SAID COMPOSITION, AND KITS FOR USING SAID COMPOSITIONS

(71) Applicant: VENJENZ, LLC, Wilkes-Barre, PA (US)

(72) Inventor: Jason DONAS, Wilkes-Barre, PA (US)

(73) Assignee: VENJENZ, LLC, Wilkes-Barre, PA (US)

(21) Appl. No.: 18/210,990

(22) Filed: Jun. 16, 2023

(51) Int. Cl. A23L 29/275; A23L 29/00; A23L 31/00; A23L 33/105; A23P 10/00

(52) U.S. Cl. CPC A23L 29/275; A23L 29/03; A23L 31/00; A23L 33/105; A23P 10/00

(57) ABSTRACT

Micronized compositions, methods of producing said micronized compositions, and kits comprising said compositions for improving healthy diets, immune systems, and/or joint health of one or more subjects are disclosed herein. The micronized compositions and kits comprise at least one micronized ingredient blend comprising micronized particles and selected from the group comprising a transfer factor blend, a mushroom blend, an enzymes and probiotics blend, a super foods blend and at least one micronized individual ingredient, wherein the at least one micronized ingredient blend is present at a concentration ranging from about 0.1 wt. % to about 30.0 wt. % and the micronized particles have average particle diameters that are either microscale- or nanoscale-sized.

### FIELD OF THE DISCLOSURE

The disclosure generally relates to one or more micronized compositions for improving healthy diets, immune systems, and/or joint health of one or more subjects, wherein the subjects may comprise humans and/or animals and/or the one or more micronized compositions may be absorbed by one or more surfaces of the subjects. The disclosure also relates to methods for producing the one or more micronized compositions by mixing or blending composition ingredients together and micronizing composition ingredients prior to mixing or blending the composition ingredients together. Moreover, the disclosure also relates to kits for using the one or more micronized compositions comprising at least one micronized composition and at least one delivery system.

### SUMMARY OF THE DISCLOSURE

In one or more embodiments, a micronized composition for improving healthy diets, immune systems, and/or joint health of one or more subjects is provided and comprises a first micronized blend of transfer factor materials comprising cow or bovine colostrum and/or derived from at least one cow colostrum extract and free of egg yolk(s), a second micronized blend of organic mushrooms, and micronized gallic acid derived from at least one natural food source, wherein micronized particles of the first micronized blend, the second micronized blend, and the micronized gallic acid have average particle diameters of less than about 8 microns.

In an embodiment, The micronized composition of claim 1, the average particle diameters are less than about 5 microns.

In an embodiment, the first micronized blend of transfer factor materials is present at a concentration from about 0.1 wt. % to about 35 wt. %, calculated to a total weight of the micronized composition.

In an embodiment, the first micronized blend, the second micronized blend, and the micronized gallic acid are present at a ratio from about 1:1:5 to about 20:5:1.

In an embodiment, the first micronized blend, the second micronized blend, and the micronized gallic acid are present at a ratio of about 1:1:5 or 20:5:1.

In an embodiment, the micronized composition further comprises at least one selected from whey protein, a third micronized blend of amino acids, micronized quercetin, and a combination thereof.

In an embodiment, the whey protein is present at a concentration of greater than about 55 wt. %, calculated to the total weight of the micronized composition.

In an embodiment, when present in the micronized composition, micronized particles of the third micronized blend and/or the micronized quercetin have average particle diameters of less than about 10 microns.

In an embodiment, the micronized gallic acid is derived from wild blueberries.

In an embodiment, the micronized composition further comprises micronized particles of quercetin having average particle diameters of less than about 10 microns.

In an embodiment, the micronized particles of quercetin are present at a concentration from about 15 wt. % to about 25 wt. %, calculated to a total weight of the micronized composition.

In one or more embodiments, a method for producing at least one micronized composition for improving healthy diets, immune systems, and/or joint health of one or more subjects is provided and comprises micronizing composition ingredients by at least one micronization process to produce a first micronized blend of transfer factor materials, a second micronized blend of organic mushrooms, and micronized gallic acid. The method further comprises mixing the first micronized blend, the second micronized blend, and the micronized gallic acid together to product a micronized composition, wherein the first micronized blend comprises cow or bovine colostrum and/or is derived from at least one cow colostrum extract and is free of egg yolk(s), micronized particles of the first micronized blend, the second micronized blend, and the micronized gallic acid have average particle diameters of less than about 10 microns, and the first micronized blend is present at a concentration from about 0.1 wt. % to about 35 wt. %, calculated to a total weight of the micronized composition.

In an embodiment, the method further comprises micronizing quercetin to produce micronized quercetin and adding the micronized quercetin to the micronized composition, wherein micronized particles of the micronized quercetin have average particle diameters of less than about 10 microns.

In an embodiment, micronized particles of quercetin are present at a concentration from about 15 wt. % to about 25 wt. %, calculated to the total weight of the micronized composition.

In an embodiment, the method further comprises micronizing amino acids to produce a third micronized blend of amino acids and adding the third micronized blend to the micronized composition, wherein micronized particles of the third micronized blend have average particle diameters of less than about 10 microns.

In an embodiment, the method further comprises mixing whey protein into the micronized composition, wherein the whey protein is present at a concentration of greater than about 55 wt. %, calculated to the total weight of the micronized composition.

In an embodiment, the at least one micronization process comprises a jet milling process and the micronized particles have average particle diameters of less than about 5 microns.

In one or more embodiments, a kit is provided and comprises the micronized composition and at least one delivery system configured to facilitate delivery of the micronized composition to at least one subject.

In an embodiment, the at least one delivery system consists of a liquid delivery system, a solid delivery system, or a combination thereof.

In an embodiment, the at least one delivery system comprises at least one selected from the group consisting of at least one pipette, at least one scooping device, and a combination thereof

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” As used herein, the phrases “selected from the group consisting of,” “chosen from,” and the like include mixtures of the specified compounds and/or materials. Terms, such as, for example, “contains” and the like are meant to include “including at least” unless otherwise specifically noted.

Herein, the term “about” when applied to a value generally means within the tolerance range of the equipment used to produce the value, or in some examples, means plus or minus 20%, plus or minus 15%, plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Where a numerical limit or range is stated, the endpoints are included. Also, all values and subranges within a numerical limit or range are specifically included as if explicitly written out. Moreover, examples herein are intended to be illustrative only and are presented for discussion purposes and not by way of limitation.

Embodiments disclosed herein relate to one or more micronized compositions for improving healthy diets, immune systems, and/or joint health of one or more subjects, wherein the subjects may comprise humans and/or animals. In some embodiments, the subjects comprise at least one human or at least one animal and/or the one or more micronized compositions may be absorbed by one or more surfaces of the subjects. In an embodiment, the one or more surfaces of the subjects comprises mucous membranes of the subjects' mouths, pores of the subjects' skins, or a combination thereof.

In one or more embodiments, the one or more micronized compositions disclosed herein may be, comprise, or consist of one or more micronized liquid compositions (hereinafter “liquid composition”), one or more micronized powdered or solid compositions (hereinafter “powdered composition”), or a combination thereof. Each liquid composition and powdered composition disclosed herein comprises a plurality of ingredients, wherein at least one ingredient of the plurality of ingredients has been micronized via at least one micronization process facilitated by one or more nano-based technologies. Natural chemistries of the micronized particles of the liquid composition and/or the powdered composition has not been changed, altered, or reconfigured by the at least one micronization process. The natural chemistries of the micronized particles allow the liquid composition and/or the powdered composition to be absorbed, in a natural manner, by the mucous membranes and/or skin pores of the subjects. In some embodiments, all ingredients of the liquid composition may be in the form of micronized particles and/or one or more ingredients of the powdered composition may be in the form of micronized particles. In other embodiments, one or more of the ingredients of the liquid composition may be in the form of micronized particles and all ingredients of the powdered composition may be in the form of the micronized particles.

In some embodiments, the phase “micronization process” as used hereinafter means or is directed to one or more processes of reducing sizes of particles. Micronization disclosed herein provides, achieves, and/or results in reductions in average diameters of one or more solid material particles which provides increased and/or improved surface areas for more efficient exposures of medicinal properties to the one or more surfaces of the subjects. As a result of the increased and/or improved surfaces areas, the one or more solid material particles may be delivered quickly and/or more rapidly into bloodstreams of the subjects. The reduction range of the one or more solid particles starts from about one micrometer to a reduction on the nanometer scale (hereinafter “nanoscale”). In some embodiments, the average diameters of micronized particles in the micronized compositions and/or ingredients disclosed herein have been reduced to the nanoscale and/or may be less than about one micrometer or less than about one micron. In at least one embodiment, the average diameters of the micronized ingredients of the micronized compositions disclosed herein are less than about one micrometer or micron and/or no more than one micrometer or micron.

Depending upon concentrations of ingredients needed and their solubilities, the medicinal material particle ingredients disclosed herein are micronized and the reduction procedure is referred to hereinafter as the “micronization” or “micronization process”. In other words, micronization as disclosed herein may refer to or be directed to a process through which average particle size ingredients, such as, for example, medicinal ingredients, may be made into and/or reduced or sized to be smaller particle sizes, such as, for example, nano-sized particles, to increase and/or improve bioavailability and effectiveness of the medicinal ingredients. In embodiments, at least one micronization technology disclosed herein is or may be directed to a mechanical only process and/or may not change chemically properties and/or characteristics in nutraceutical materials or multi-material ingredient formulas set forth herein. Moreover, liquid-based nanoparticle ingredients set forth herein may be, comprise, or consist of one or more nano-sized particles that may be more easily dispersed and/or may be more soluble than larger-sized particles in a liquid due to their smaller size, and the liquid itself may aid or help to quickly and fully disperse the nano-sized particles onto the one or more surfaces (i.e., mucus membranes) of the subjects unlike a dry powder could do.

Further, the present disclosure relates to kits for using the one or more micronized compositions comprising at least one micronized composition and at least one delivery system. The at least one delivery system may deliver, supply, and/or transport the liquid composition or the powdered composition to the surfaces of the subjects for absorption by the surfaces of the subjects. For the liquid composition, the at least one delivery system may be, comprise, or consist of at least one liquid delivery system; and, for the powdered composition, the at least one delivery system may be, comprise, or consist of at least one solid delivery system. In at least one embodiment, the at least one liquid delivery system may be, comprise, or consist of at least one pipette and/or the at least one solid delivery system may be, comprise, or consist of at least one scooping device. In some embodiments, the dosage of the one or more micronized compositions deliverable to the subject may be for example, about 1 milliliter, about 20 drops, about 1 scoop, or about 20 grams. For the powdered composition, the dosage may be mixed with a water- or aqueous-based fluids, such as, for example, water, milk, a health beverage, or a combination thereof.

In one or more embodiments, the micronization disclosed herein is and/or provides a better and improved delivery system technology for the natural medicines set forth herein. The micronization may be crucial or at least important or substantially important for making and formulating improved and more efficient, fast-acting, and/or reliable medicinal ingredient products without the known problems associated with traditional digestive dependent delivery systems. Often, known digestive dependent medicinal delivery systems, such as, for example, capsules, tablets, powders and also liquids that do not contain micronized ingredients are inefficient when compared to the micronized dropper and/or spray liquid medicinal delivery systems disclosed herein. The present micronized delivery systems at a nano-sized level may be quickly absorbed through the cell walls of the mucus membranes of the subjects in a transdermal process allowing for the by-passing of medicinal ingredients through the usual alimentary canal digestive process which takes longer and is less efficient and less bioavailable by comparison.

Unlike known CO₂ processing, freeze-drying, use of solvents and/or other invasive techniques to make medicinal ingredients more effective, the micronization disclosed herein is or may be non-invasive because the present micronization is merely a physical methodology that does not chemically change the profile of the present micronized particle. Instead, the micronization disclosed herein merely makes the particle smaller using mechanical means to provide the present micronized particles, micronized ingredients, and/or micronized compositions. The present micronization disclosed herein does not invasively change the chemistry of the medicinal particle material as invasive techniques typically can do. Instead, the non-invasive micronization methods utilized herein reduce medicinal product ingredients into nano-sized particles that may be easily absorbed into the body of the subjects and function more efficiently and naturally than other known delivery methods. The present micronization disclosed herein may offer vastly improved bioavailability of active medicinal ingredients to the subjects. Furthermore, the reduction range of the particles disclosed herein may start from about one micrometer to a reduction on the nanometer scale measurable by nanometers instead of micrometers.

In some embodiments, the micronization process(es) disclosed herein may reduce the particle size of the composition ingredients and/or blends down to a few micrometers to enhance bioavailability. In one or more embodiments, the micronization process(es) disclosed herein may reduce the particle size of the composition ingredients and/or blends into one or more micrometer or nanometer ranges, such as, for example, equal to or less than about 10 microns. In more than one embodiment, the resulting particles sizes of the composition ingredients and/or blends, after the utilizing and/or completing the micronization process(es) disclosed, may be less than or equal to about 1 micron or 1,000 nanometers. In some embodiments, the resulting particles sizes may be in nano-size ranges from about 100 nanometers to about 900 nanometers, from about 125 nanometers to about 800 nanometers, from about 150 nanometers to about 700 nanometers, from about 175 nanometers to about 600 nanometers, or from about 200 nanometers to about 500 nanometers. The micronization process(es) disclosed herein may alter, change, adjust, or manipulate one or more properties of the composition ingredients and/or blends, wherein the one or more properties may be, comprise, or consist of one or more particle shapes, one or more surface areas, one or more porosities, or a combination thereof. As a result, micronized composition ingredients and/or blends disclosed herein may improve, ensure, and/or maintain uniform content therefo, uniform flow thereof, uniform mixing capabilities thereof, or at least one combination thereof. In at least one embodiment, the micronization process(es) disclosed herein may utilize

In one or more embodiments, the micronization process(es) may be achieved, executed, and/or performed using or utilizing at least one nano-milling process, at least one jet milling process, at least one media milling process, or a combination thereof. In at least one embodiment, the micronization process(es) disclosed herein may comprise, use, and/or incorporate at least one supercritical fluid into the milling process for micronization. During the milling process for micronization, the at least one supercritical fluid may be heated above its critical temperature to achieve a intermediate state that is between its gas state and its liquid state. In an embodiment, the at least one supercritical fluid may be, comprise, or consist of carbon dioxide. In at least one embodiment, the at least one nano-milling process, the at least one jet milling process, the at least one media milling process disclosed herein may utilize and/or incorporate one or more cryogenic mills and liquid nitrogen to lower temperatures of mill feeds of the milling process for micronization. In an embodiment, the at least one media mlling process disclosed herein may be, comprise, or consist of at least one wet media milling process.

In some embodiments, the at least one jet milling process may utilize and/or incorporate at least one compressed gas source that expands at an outlet of a plurality of grinding nozzles and accelerates particles of the composition ingredients or blends in a spiral vortex flow path within at least one grinding chamber of at least one jet mill. For example, the at least one jet mill may utilize, use, or incorporate high-pressure, turbulent condensed gas to force high-velocity collisions between particles of the composition ingredients and/or blends that reduce the particles sizes to the nano-size ranges for micronization. As a result of utilizing the at least one jet mill, smaller particles of the composition ingredients and/or blends may be dispersed into the gas stream, discharged into a cyclone filter, and/or progressively collected for use. In more than one embodiments, the turbulent condensed gas may be air, nitrogen, argon, helium, or a combination thereof at a high-pressure range and the average particle size may be from about 1 micron to about 10 microns. In an embodiment, the high-pressure range may be from about 10 pounds per square in gauge (hereinafter “psig”) to about 200 psig, from about 25 psig to about 150 psig, or from about 50 psig to about 120 psig. In other embodiments, the high-pressure range may be from about 75 psig to about 300 psig, from about 90 psig to about 25 psig, or from about 100 psig to about 220 psig and gas may be heated to a temperature range from about 300° F. to about 1200° F., from about 350° F. to about 1150° F., or from about 390° F. to about 1000° F.

In at least one embodiment, the at least one jet milling process disclosed herein may be controlled by one or more of the following operating parameters: material feeding rate; feeding pressure; and grinding pressures. The jet milling process disclosed herein may be thermally stable, wherein heat produced by a jet mill may be dispersed by adiabatic cooling as the gas expands. In at least one embodiment, the average diameter of the micronized composition ingredients and/or blends may be greater than 1 micron, may be less than about 10 microns, less than about 8 microns, or less than about 5 microns or may be about 8 microns, about 5 microns or about 3 microns.

In some embodiments, the present nano-sized particle ingredients disclosed herein may be incorporated or included into at least one liquid base which may allow the resulting products to be very bioavailable meaning that, upon contact with the body of the subject, the medicinal nano-sized particles may immediately pass or go through and/or transverse cell walls of the subjects and into the bloodstreams of the subjects for distribution throughout the subject bodies to target any specific health condition the medicinal nano-sized particles are designed to address. The present non-invasive delivery system of medicinals disclosed herein is more efficient and superior to known intravenous injections as an improved and synergistic medicinal delivery system since the known intravenous medicinals are not micronized. In at least one embodiment, all or substantially all ingredients of the active ingredients disclosed herein are reduced to nano-sized and/or micronized particles which provide improved absorption and bioavailability to the surfaces of the subjects. In at least one embodiment the micronization delivery system disclosed herein may offer better and/or improved exposure to the body, as a whole or at least a partial whole, of the subjects and/or advanced and/or improved time-release and targeting benefits.

In one or more embodiments, the present nano-sized medicinal particles disclosed herein may penetrate the cell walls of the subject bodies and/or deliver the medicine to any part of the subject bodies on the nano-sized scale, whereas known medicinal particles that are cycled through the digestive system may ultimately remain larger in particle size even after the digestive process and are not as easily processed by the subject bodies for medicinal delivery purposes. Because of the small sizes and/or abilities to penetrate cell walls the present nano-sized medicinal particles disclosed herein may be about hundreds of times more efficiently delivered than non-nano or regular-sized particles processed through normal digestion. The present nano-sized medicinal particles disclosed herein may provide improved bioavailability and efficiencies that make the nano-sized medicinal particles up to about one-hundred times more potent and useful than larger amounts of regular particle size with conventional and known delivery systems. The present nano-sized nutraceuticals disclosed herein may provide improved abilities to target the organs or bodily systems of the subjects in which one or more health condition imbalances may exist. In at least one embodiment, one or more amazing abilities of the present nano-sized particles may be utilized by the intelligence of the subject bodies to deliver the present nano-sized medicinals and/or provide improved balances to one or more bodily functions of the subjects and/or establish optimal health of the subjects.

In some embodiments, the present nano-sized nutraceuticals disclosed herein may provide improved time-release benefits based on improved efficiencies wherein the nano-sized nutraceuticals may be fully dispersed throughout the subject bodies. As a result, at least one storage efficiency may be more easily or automatically created in the subject bodies with the present nano-sized particles that is more pronounced and improved than the storage efficiency provided by known nutraceutical particles of larger sizes processed through normal digestion of the subjects. In contrast, most known nutraceuticals and remedies for health conditions in the form of food supplements are delivered in conventional manners, such as, for example, in the form of tablets, powders, capsules or liquids, wherein the supplement formula ingredients are offered in their raw states, extract states, or a combination of both raw and extract states. Whereas the present micronized nutraceutical formula ingredients reduced to nano-sized particles as disclosed herein may be offered or provided with one or more conventional delivery systems or the present micronized ingredients may be suspended in liquid and offered or provided as liquid delivery systems in nano-sized particles which may be the best and most efficient delivery systems for the present micronized ingredients.

In one or more embodiments, the liquid delivery systems of the medicinal nano-sized particles may provide better or improved efficiencies because the present medicinal nano-sized particles in liquids may have or provide direct and complete contact with the mucus membranes of the subject bodies when taken or received orally into the subject mouths or onto eatables that may also have direct contacts with the mucus membranes of the subject bodies. As a result, the present nano-sized medicinal particles may immediately penetrate the mucous membrane cell wall linings trans dermally in the mouths, noses, throats or lungs of the subjects and/or may enter the bloodstreams where the medicinally active nano-sized particles may enter into all the cells of the subject bodies through the circulatory systems of the subjects. For example, the present nano-sized particles may penetrate the “blood-brain barrier” or the cell walls of any cell organism in the subject bodies. Further, the present nano-sized particles may penetrate the red blood cells which may be used to transport the nano-sized medicinals to any useful or beneficial system(s) or area(s) of the subject bodies. Moreover, direct transdermal deliveries of the present nano-sized medicinal particles may help to avoid or at least substantially avoid one or more metabolism issues regarding slow or retarded absorption or digestive issues with respect to the subject bodies.

### Composition Ingredients

In one or more embodiments, the plurality of ingredients of the liquid composition and/or the powdered composition may comprise at least one ingredient blend, a plurality of ingredient blends, at least one individual ingredient, a plurality of individual ingredients, or a combination thereof. In some embodiments, the plurality of ingredient blends may comprise at least one first ingredient blend, at least one second ingredient blend, at least one third ingredient blend, at least one fourth ingredient blend, or up to about five ingredient blends. The plurality of individual ingredients may comprise up to about fifteen individual ingredients, up to about twenty individual ingredients, or up to about twenty-five individual ingredients.

### Ingredient Blends

In one or more embodiments, the liquid composition and/or the powdered composition may comprise the plurality of ingredient blends, the plurality of individual ingredients, or a combination thereof. In some embodiments, the at least one first ingredient blend, the at least one second ingredient blend, the at least one third ingredient blend, and/or the at least one fourth ingredient blend may be, comprise, or consist of at least one transfer factor blend, at least one mushroom blend, at least one probiotic and/or enzyme blend, at least one amino acid blend, at least one super foods blend, or a combination thereof. In at least one embodiment, the at least one first ingredient blend, the at least one second ingredient blend, the at least one third ingredient blend, and/or the at least one fourth ingredient blend may be present at a concentration ranging from about 0.1 wt. % to about 30.0 wt. %, from about 0.2 wt. % to about 26.0 wt. %, or from about 5.0 wt. % to about 24.0 wt. %, wherein all wt. % concentrations are based on a total weight of the liquid composition or the powdered composition.

In some embodiments, the at least one transfer factor blend may be, comprise, or consist of at least one transfer factor ingredient and one or more option transfer factor additives. In at least one embodiment, the at least one transfer factor ingredient may be, comprise, or consist of at least one chemical substance that is taken from, derived from, and/or based on at least one human and/or at least one animal that has already developed protection (immunity) against a certain disease. In an embodiment, the at least one transfer factor ingredient may be, comprise, or consist of one or more immune messenger molecules produced by one or more higher organisms, may have a molecular weight of about 5000 Daltons, and/or may be, comprise, or consist one or more amino acids. In some embodiments, the at least one transfer factor blend may be present at a concentration ranging from about 0.1 wt. % to about 30.0 wt. %, from about 0.15 wt. % to about 27.5 wt. %, or from 0.2 wt. % to about 26.0 wt. %, wherein all wt. % concentrations are based on the total weight of the liquid composition or the powdered composition.

In one or more embodiments, the at least one transfer factor blend disclosed herein may be at least one naturally sourced transfer factor blend, at least one non-GMO transfer factor blend, at least one full-spectrum extract transfer factor blend with a plurality of immunoglobulins intact, and/or at least one micronized transfer factor blend for efficient and improved absorptions. In some embodiments, the at least one transfer factor blend disclosed herein may be, comprise, or consist of one or more transfer factor ingredients derived from and/or based on cow or bovine colostrum only and/or may not contain, comprise, or consist of egg yolks or any other non-dairy allergen sources. In some embodiments, the at least one transfer factor blend disclosed herein may be free of or at least substantially free of egg yolk(s) or any other non-dairy allergen source(s) and/or may comprise or consist solely of cow or bovine colostrum. In at least one embodiment, the at least one transfer factor blend disclosed herein is entirely free of the egg yolk(s) and all other non-dairy allergen source(s) and/or comprises or consists solely of cow or bovine colostrum. Moreover, one or more polypeptides of the present at least one transfer factor blend may have, comprise, or consist of molecular weights of about 2,500 Daltons, about 5,000 Daltons, about 7,500 Daltons or about 10,000 Daltons. In an embodiment, the present at least one transfer factor blend is, comprises, consists of, or is composed entirely or at least partially of one or more amino acids having, comprising, or consisting of the molecular weight(s) disclosed herein.

In some embodiments, the presence of transfer factor blend disclosed herein may be, comprise, or consist of transfer factor materials that are derived from cow colostrum extracts containing antigen information. As a result, the presence of transfer factor blend may provide a broad spectrum of transfer factor materials. In at least one embodiment, the transfer factor materials of the transfer factor blend disclosed herein is entirely free of the egg yolk(s) and all other non-dairy allergen source(s) and/or comprises or consists solely of the cow colostrum extracts. The transfer factors disclosed herein may educate the immune system of the subjects to recognize pathogens and/or support healthy immune system functions of the subjects. In some embodiments, the transfer factor disclosed herein may be, comprise, or consist of at least one chemical taken from a human or animal that has already developed protection (immunity) against certain diseases. In at least one embodiment, the transfer factors disclosed herein may be a group of proteins produced by cells of the immune system and usable to treat many health conditions related to immune deficiencies. In an embodiment, the transfer factors disclosed herein may essentially be small immune messenger molecules that are produced by higher organisms and may be a part of the immune system and represent “an archaic dialect in the language of cells.” To communicate between cells, the immune system may employ hormone-like signal substances; the transfer factors may be one class of such immune system communication substances and/or may include both inducer/helper functions (i.e. inducer factors) and/or regulator functions (i.e., regulator factors) that historically are called “suppressor functions”. The inducer factors may translate an apparently mature immune response from the donor to the recipient and/or the regulator factors may help control overreactions and limit allergies and autoimmune conditions. The transfer factors may induce an immune response in less than 24 hours and/or may not be species-specific. The transfer factors disclosed herein may be trans-species; thus, the transfer factors may be produced by a cow's immune system are just as effective in humans, dogs or cats as they are in the cow. The exact identity (protein primary structure) of the transfer factor may be unknown, but High-Performance Liquid Chromatography (HPLC) studies suggest that a common part in them may be the fragment LLYAQD [LV] EDN, a sequence not found in any mammalian genomes. Colostrum is a form of milk produced by the mammary glands of mammals (including humans) in late pregnancy which may contain multiple immune modulating molecules, including high antibody levels.

In one or more embodiments, the transfer factor molecules disclosed herein may provide the immune systems of the subjects with specific and/or necessary information, such as, for example, information for recognizing pathogens (i.e., viruses, bacteria, fungal, and/or parasites), responding by killing these pathogens, and/or remembering them when the pathogens return come back. The transfer factors disclosed herein may be polypeptide molecules that “educate” cells by binding to antigens without being consumed. Unlike antibodies, the transfer factors may give the immune system the ability to identify harmful bacteria or viruses so that it continues to adapt to new threats while providing balanced self-regulation to help prevent adverse health conditions. The transfer Factor disclosed herein may be a scientifically proven means of immune communication at the cellular level. Produced by the immune system, it is naturally designed to transfer highly concentrated, easily usable immune intelligence from one immune system to another, as from a human mother to her baby through her colostrum or “first milk.” In an embodiment, the transfer factor molecules disclosed herein may be polypeptides (i.e., PRPs), molecules that may be filtered and concentrated from cow (bovine) colostrum and then micronized as a micronized delivery system (i.e., micronized compositions comprising micronized liquid and/or powdered compositions) of transfer factor into the bodies of the subjects. The transfer factor from mammals may enable animal mothers to pass their lifetime “database” on encounters with infective agents to their newborn offspring and/or the transfer factor may be a chemical that is taken from a human or animal that has already developed protection (immunity) against certain diseases. In some embodiments, the transfer factors may essentially be small immune messenger molecules that are produced by all mammals and highly evolved organisms. Because transfer factor is trans-species, meaning that it works uniquely in multiple species, transfer factor molecules have also proven to be essentially identical among different species, and therefore capable of communicating immune system knowledge from one species to another. For example, transfer factor from cow colostrum has the same positive action of transferring immunity information for a calf as it does for a dog, cat or human. While antibiotics and other drugs tend to work instead of the immune system, transfer factor naturally supports the functioning of the immune system of the subjects. In an embodiment, the transfer factor blend from cow's colostrum may contain concentrated amounts of lgG's or immunoglobulins, wherein the IgG's are antibodies with potent, broad-based antiviral and antibacterial abilities by which they help prevent infections. IgG may be used to address immune system problems and infections. Bovine colostrum (cows milk colostrum) may contain more lgG than any other immunoglobulin sources. As a result, transfer factors may be useful in supporting and improving the strength and efficiency of the immune system for disease prevention.

In one or more embodiments, the at least one mushroom blend may be, comprise, or consist of at least one of reishi, cordyceps, chaga, lion's mane, maitake, shiitake, or a combination thereof. In some embodiments, the at least one mushroom blend may be, comprise, or consist of reishi, cordyceps, chaga, lion's mane, maitake, and/or shiitake. In at least one embodiment, the at least one mushroom blend may be present at a concentration ranging from about 0.1 wt. % to about 10.0 wt. %, from about 0.15 wt. % to about 7.5 wt. %, or from about 0.2 wt. % to about 6.5 wt. %, wherein all wt. % concentrations are based on the total weight of the liquid composition or the powdered composition. In some embodiments, the at least one mushroom blend may comprise changa, cordyceps, reishi, lion's mane, maitake, and/or shiitake. The at least one mushroom blend may also contain one or more glucans which may support the positive functioning of the transfer factor and/or may contain naturally occurring glutamine peptides that contribute to balancing and/or lowering cortisol levels contributing to the reduction of stress-related issues. In an embodiment, the at least one mushroom blend may contain Vitamin D at a dose of about 5000 IU. Even a minuscule amount of vitamin D when micronized may act as hundred (i.e., 100×) or more times the usual digestive amount of vitamin D as found in a daily supplement (which is usually synthetic).

In some embodiments, the at least one probiotic and/or enzyme blend may be, comprise, or consist of at least one select from one or more enzymes, one or more probiotics, one or more prebiotics, one or more botanics and/or nutraceuticals, or a combination thereof. In some embodiments, the one or more enzymes may be, comprise, or consist of at least one selected from amylase, lipase, cellulase, protease, xylanase, phytase, bromelain, papain, or a combination thereof. Additionally, the one or more probiotics may be, comprise, or consist of at least one selected from Lactobacillus acidophilus, Lactobacillus rhamnosus, Lactobacillus salivarius, Lactobacillus paracasei, Bifidobacterium bifidum, Bifidobacterium breve, or a combination thereof. Further, the one or more prebiotics may be, comprise, or consist of inulin. Still further, the one or more botanics and nutraceuticals may be, comprise, or consist of at least one selected from ginger, fennel, marshmallow root, papaya leaf, turmeric/curcumin, selenium, or a combination thereof. In at least one embodiment, the at least one probiotic and/or enzyme blend may be present at a concentration ranging from about 0.1 wt. % to about 10.0 wt. %, from about 0.15 wt. % to about 7.5 wt. %, or from about 0.2 wt. % to about 6.5 wt. %, wherein all wt. % concentrations are based on the total weight of the liquid composition or the powdered composition.

In one or more embodiments, the at least one probiotic and/or enzyme blend help support the immune system of the subjects and/or may comprise lactic acid producing bacteria and yeast cell wall ingredients known to help support immune system functions of subjects. In some embodiments, the at least one probiotic and/or enzyme blend may also comprise, contain, and/or consist of one or more of the following probiotics: Lactobacillus acidophilus; Lactobacillus rhamnosus; Lactobacillus salivarius; Lactobacillus paracasei; Bifidobacterium bifidum; Bifidobacterium breve; and a mixture thereof. In an embodiment, a prebiotic and/or inulin may also be included to help support the probiotic action. Enzymes may be included and/or used by the digestive system for breaking down proteins and to assist in general digestive processes for a healthy digestion of foods. The at least one probiotic and/or enzyme may also comprise, contain, or consist of one or more of the following probiotics and enzymes: amylase; lipase cellulase protease; xylanase; phytase; bromelain; papain; or a combination thereof. In some embodiments, the enzymes may be papain from papaya and bromelain from pineapples and amylase, protease, lipase and/or cellulase as derived by yeast fermentation which may be base foods and/or tend to be naturally stable. In an embodiment, natural fruit citric acid from lemons and oranges may be added or utilized as a natural preservative. The probiotics that may be usable may include Bifidobacterium and Lactobacillus strains having a normal moisture content of less than 2% in their natural state. As a result, the probiotics may be generally stable at room temperature and/or there may be no fermentation with the natural fruit citric acid preservative added fermentation. In an embodiment, the at least one enzyme and probiotic blend may be, comprise, contain, or consist of amylase, lipase, cellulase, protease, xylanase, phytase, bromelain, papain, Lactobacillus acidophilus, Lactobacillus rhamnosusillion, Lactobacillus salivarius, Lactobacillus paracasei, Bifidobacterium bifidum, Bifidobacterium breve, Enterococcus faecium, Bifidobacterium lactis, Lactobacillus casei, Bifidobacterium breve, Lactobacillus plantarum, fructo-oligosaccharides, mannan-oligosaccharides, inulin, ginger, fennel, marshmallow root, papaya leaf, turmeric/curcumin, selenium, or a combination thereof.

In one or more embodiments, the at least one amino acid blend may be, comprise, or consist of at least one selected from L-Leucine, L-Valine, L-Isoleucine, L-Lysine, L-Phenylalanine, L-Threonine, L-Methionine, L-Tryptophane, L-Histidine, L-Glutamine, L-Camitine, L-Proline, L-Glycine, L-Arginine, L-Cystine, L-Cystiene, L-Carnitine, L-Tyrosine, L-Taurine, or a combination thereof. In some embodiments, the at least one amino acid blend may be, comprise, or consist of L-Leucine, L-Valine, L-Isoleucine, L-Lysine, L-Phenylalanine, L-Threonine, L-Methionine, L-Tryptophane, L-Histidine, L-Glutamine, L-Camitine, L-Proline, L-Glycine, L-Arginine, L-Cystine, L-Cystiene, L-Carnitine, L-Tyrosine, and/or L-Taurine. In at least one embodiment, the at least one amino acid blend may be present at a concentration ranging from about 0.05 wt. % to about 10.0 wt. %, from about 0.1 wt. % to about 7.5 wt. %, from about 0.15 wt. % to about 5.0 wt. %, or from about 2.0 wt. % to about 3.0 wt. %, wherein all wt. % concentrations are based on the total weight of the liquid composition or the powdered composition.

In some embodiments, the at least one super foods blend may be, comprise, or consist of at least one selected from broccoli, kale, blueberry, tart cherry turmeric, moringa, green tea, green coffee, beets, alfalfa grass, wheat grass, spirulina, chlorella, cauliflower, celery, spinach, carrot, broccoli sprout, kale, cucumber, quinoa, senonian soil mineral blend including fulvic, humic acids or a combination thereof, purslane, oats, or a combination thereof. In some embodiments, the at least one super foods blend may be, comprise, or consist of broccoli, kale, blueberry, tart cherry turmeric, moringa, green tea, green coffee, beets, alfalfa grass, wheat grass, spirulina, chlorella, cauliflower, celery, spinach, carrot, broccoli sprout, cucumber, and/or quinoa. In embodiments, the senonian soil mineral blend may be, comprise, or consist of aluminum, hafnium, rhenium, antimony, holmium, rhodium, arsenic, indium, rubidium, barium, iodine, ruthenium, beryllium, iridium, samarium, bismuth, iron, scandium, boron, lanthanum, selenium, bromine, lead, silicon, cadmium, lithium, silver, calcium, lutetium, sodium, carbon, magnesium, strontium, cerium, manganese, sulfur, cesium, mercury, tantalum, chloride, molybdenum, tellurium, chromium, neodymium, terbium, cobalt, nickel, thallium, copper, niobium, thorium, dysprosium, nitrogen, thulium, erbium, osmium, tin, europium, oxygen, titanium, fluoride, palladium, tungsten, gadolinium, phosphorus, vanadium, gallium, platinum, ytterbium, germanium, potassium, yttrium, gold, praseodymium, and/or zinc. In at least one embodiment, the at least one super foods blend may be present at a concentration ranging from about 10.0 wt. % to about 50.0 wt. %, from about 15.0 wt. % to about 40 wt. %, from about 20.0 wt. % to about 30.0 wt. %, or from about 22.5 wt. % from about 27.5 wt. %, wherein all wt. % concentrations are based on the total weight of the liquid composition or the powdered composition. In an embodiment, purslane may be air-dried, purslane steam-treated organic powder and/or the oats may be udderly organic oat powder.

### Individual Ingredients

In one or more embodiments, the at least one individual ingredient and/or the plurality of individual ingredients may be, comprise, or consist of at least one selected from shilajit, ashwagandha, organic dulse, bacopa monnieria, omega-3, camu camu, moringa, quercetin, bhringraj, guduchi, boswellia serrata, turmeric, tulsi, one or more favoring additives, zeolite, glucosamine sulfate, chondroitin sulfate, guggul extract, collagen, collagen concentrate, protein supplement additive, at least one emulsifier additive, at least one water- or aqueous-based fluid, one or more flavor additives, organic medium-chain triglycerides (hereinafter “MCT”) oil, lions mane extract, mucuna, Tribulus terrestris, tongkat ali, fadogia, lecithin powder, monk fruit, or a combination thereof. In some embodiments, the one or more favoring additives may be, comprise, or consist of one or more flavor/sweetener and/or preservative additives. In an embodiment, the one or more favoring additives may be, comprise, or consisted of at least one selected from natural french vanilla, orange flavor, natural fruit citric acid, lo han or Siraitia grosvenorii, or a combination thereof. In some embodiments, the protein supplemental additive may be, comprise, or consist of at least one whey protein additive. In an embodiment, the protein supplemental additive may be, comprise, or consist of at least Australian whole whey protein concentrate and/or the at least one emulsifier additive may be, comprise, or consist of at least sunflower lecithin. In at least one embodiment, the at least one water- or aqueous-based fluid may be, comprise, or consist of water. In an embodiment, the water may be, comprise, or consist of purified water.

In some embodiments, the micronized compositions disclosed herein may have, exhibit, and/or achieve, may comprise, or may consist of one or more antifungal, anti-inflammatory, antimicrobial, anti-obesity, antioxidant, and antiviral benefits, characteristics, and/or properties. As a result, the micronized compositions disclosed herein may modulate immune systems of the subjects and/or act as natural defense mechanisms against bacterial, microbial and/or viral infections. In at least one embodiment, the micronized compositions disclosed herein have, exhibit, and/or achieve, comprise, or consist of antifungal, anti-inflammatory, antimicrobial, anti-obesity, antioxidant, and/or antiviral benefits, characteristics or properties.

In at least one embodiment, the least one individual ingredient and/or the plurality of individual ingredients of the micronized compositions disclosed herein may be, comprise, or consist of gallic acid in micronized form which is a micronized phenolic acid and/or bioactive compound. Gallic acid (also known as 3,4,5-trihydroxybenzoic acid) is an antioxidant based on phenolic acid and is found in plants at a plurality of different amounts and/or concentrations. For example, gallic acid may be naturally found in one or more food sources and/or one or more plants, such as, the bark of oak species and Boswellia dalzielii. Some food sources comprising gallic acid may include strawberries, grapes, bananas, blueberries, apples, walnuts, cashews, hazelnuts, red wines, green teas, avocados, blackcurrants, guavas, mangos, mulberries, pomegranates, or a combination thereof.

In some embodiments, the micronized gallic acid of the present micronized compositions may come from, be sourced from, and/or be derived or extracted from wild blueberries. For example, wild blueberries contain or comprise gallic acid, which may contribute to antioxidant properties of the present micronized compositions and/or gallic acid content in wild blueberries may vary depending on factors, such as, the variety of blueberry, growing conditions, and/or maturity. Gallic acid in wild blueberries may act as an antioxidant, help to neutralize harmful free radicals in the body, protecting cell of the subjects from oxidative stress, and/or reduce the risk of chronic diseases. Wild blueberries, including their gallic acid content, may be associated with various health benefits, may be rich in anthocyanins, another type of antioxidant, linked to improved cognitive function, cardiovascular health, and/or anti-inflammatory effects. Gallic acid found in wild blueberries may help inhibit the growth of cancer cells and induce cell death (apoptosis) in certain types of cancer. In an embodiment, the micronized gallic acid of the present micronized compositions may be sourced and/or derived or extracted solely from wild blueberries. In one or more embodiments, the at least one individual ingredient and/or each ingredient of the plurality of individual ingredients may be present at a concentration ranging from about 1.0 wt. % to about 35.0 wt. %, from about 2.5 wt. % to about 30.0 wt. %, from about 3.0 wt. % to about 25 wt. %, or from about 5.0 wt. % to about 20.0 wt. %, wherein all wt. % concentrations are based on the total weight of the micronized composition, the liquid composition or the powdered composition. In some embodiments, the at least one individual ingredient and/or each ingredient of the plurality of individual ingredients may be present at a concentration ranging from about 2.0 wt. % to about 35.0 wt. %, from about 4.0 wt. % to about 30.0 wt. %, from about 6.0 wt. % to about 25.0 wt. % from about 8.0 wt. % to about 20.0 wt. %, from about 10.0 wt. % to about 17.5 wt. %, or from about 12.5 wt. % to about 15.0 wt. %, wherein all wt. % concentrations are based on the total weight of the micronized composition, the liquid composition, or the powdered composition. In other embodiments, the at least one individual ingredient and/or each ingredient of the plurality of individual ingredients may be present at a concentration ranging from about 0.05 wt. % to about 75.0 wt. %, from about 0.1 wt. % to about 70.0 wt. %, from about 0.2 wt. % to about 65.0 wt. %, from about 0.4 wt. % to about 60.0 wt. %, from about 0.6 wt. % to about 55.0 wt. %, from about 0.8 wt. % to about 50.0 wt. %, from about 1.0 wt. % to about 40.0 wt. %, from about 2.0 wt. % to about 30.0 wt. %, from about 5.0 wt. % to about 25.0 wt. %, from about 7.5 wt. % to about 20.0 wt. %, or from about 10.0 wt. % to about 15.0 wt. %, wherein all wt. % concentrations are based on the total weight of the micronized composition, the liquid composition, or the powdered composition.

### EXAMPLES

In the following examples, formulations for the one or more one or more micronized compositions (for improving healthy diets, immune systems, and/or joint health of one or more subjects) are provided.

### Example 1: Immune Formulation

wt. % of total weight of formulation

| Liquid ingredients | wt. % of total weight of |
|---|---|
| Transfer Factor Blend | 25.8 |
| Mushroom Blend | 6.45 |
| Enzymes & Probiotics Blend | 6.45 |
| Shilajit(Asphaltum puniabiunum) | 3.22 |
| Ashwagandha(1.5% withanolides) | 3.22 |
| Dulse (0.05 Dulse Sea Lettuce) | 3.22 |
| BacopaMonnieria(10% bacosides) | 3.22 |
| Omega-3(SachaInchiProteinPdr = 5%) | 6.45 |
| Camu Camu(20% Vitamin C) | 3.22 |
| Moringa(Full Spectrum) | 3.22 |
| Quercetin(Extract-Quercetin Flavonoid) | 19.35 |
| Bhringraj(Eclipta alba, Raw or Extract) | 3.22 |
| Guduchi(Tinospora cordifolia) | 3.22 |
| Boswellia serrata(65% Extract) | 3.22 |
| Turmeric(Curcuma longa) | 3.22 |
| Tulsi(0.05 Holy Basil) | 3.22 |
| Wt. % TOTALS: | 100% |

Flavors as Needed

### Example 2: Joint/Anti-Inflammation Formulation

| | wt. % of total weight |
|---|---|
| Liquid ingredients | of formulation |
| Zeolite(Clinoptilolite Zeolite from Zeo Health) | 6.25 |
| Glucosamine Sulfate (From Shell Fish) | 10 |
| Chondroitin sulfate (From Bovine and/or shark source) | 10 |
| Turmeric (95% Curcuminoids) | 12.5 |
| Guggul Ext.(Commiphora mukul 10% Guggulipids) | 12.5 |
| Camu Camu (20% Vitamin C) | 6.25 |
| Collagen Conc. (Green-Lipped Mussel) | 17.5 |
| Boswellia serrata (65% Boswellic acids) | 25 |
| Flavoring (Fruit Source Citric Acid & Other) | |
| Wt. % TOTALS: | 100 |

### Example 3: Meal Replacement Formulation

| | wt. % of |
|---|---|
| | total weight |
| Ingredients | of formulation |
| Whey Protein (80% Aglomerated Instantized Grass fed) | 58.29300484 |
| Amino Blend | 0.219973603 |
| Transfer Factor Blend | 0.219973603 |
| Flavor (Vanilla or Choc Natural Flavors) | 8.798944127 |
| Collagen (Bovine Source Collagen Pdr.) | 1.099868016 |
| MCT oil (Organic) | 0.65992081 |
| Probiotics & Enzymes Blend | 0.219973603 |
| Mushroom Blend | 0.219973603 |
| Ashwagandha (1.5% withanolides) | 1.099868016 |
| Lions Mane (Extract) | 1.099868016 |
| Mucuna (Pruriens 15% L-DOPA) | 0.879894413 |
| Moringa (NOSG VITAMIN BLEND) | 2.199736032 |
| Super Foods Blend | 23.097346 |
| Tribulus terrestris (45% Saponins) | 0.439947206 |
| Tongkat ali | 0.439947206 |
| Fadogia (agrestis) | 0.439947206 |
| Shilajit (Trace Minerals) | 0.219973603 |
| Lecithin Pdr. (Sunflower Lecithin) | 1.099868016 |
| Monk Fruit (80% Mongrosides Ext.) | 0.131984162 |
| Wt. % Totals: | 100 |

### Example 4

| | | | | wt.% of total |
|---|---|---|---|---|
| | Grams | | | weight of |
| Ingredient | 2 oz | 1 oz | Description | formulation |
| Immunel | 0.400 | 0.200 | | 25.8065% |
| Enzymes & Probiotics | 0.100 | 0.050 | | 6.4516% |
| Mushrooms Blend | 0.100 | 0.050 | Reishi, Cordyceps, Chaga, Lion's | 6.4516% |
| | | | Mane, Maitake, Shiitake | |
| Ashwagandha | 0.050 | 0.025 | 1.5% withanolides | 3.2258% |
| Moringa | 0.050 | 0.025 | Extract 10:1 | 3.2258% |
| Shilajit | 0.040 | 0.020 | Extract 4:1 | 2.5807% |
| Dulse Organic | 0.050 | 0.025 | Dulse Sea Lettuce | 3.2258% |
| Bacopa | 0.050 | 0.025 | Bacopa monnieri 10-20% bacosides | 3.2258% |
| Omega-3 | 0.100 | 0.050 | Sasha inchi Powder 5% Omega | 6.4516% |
| Camu Camu | 0.050 | 0.025 | 20% Vitamin C | 3.2258% |
| Quercetin | 0.300 | 0.150 | Extract Flavonoid | 19.3548% |
| Bhringraj | 0.040 | 0.020 | Eclipta alba | 2.5807% |
| Guduchi | 0.050 | 0.025 | Tinospora cordifolia RAW | 3.2258% |
| Wild Blueberry | 0.020 | 0.010 | Gallic Acid | 1.2903% |
| Boswellia serrata | 0.050 | 0.025 | Extract 65% | 3.2258% |
| Turmeric | 0.050 | 0.025 | Curcuma longa RAW | 3.2258% |
| Tulsi | 0.050 | 0.025 | Holy Basil | 3.2258% |
| Other Ingredients | 0.000 | 0.000 | Fruit Source Citric Acid (Lemon Rind) | 0.0000% |
| Totals | 1.550 | 0.775 | | 100.00% |
| Other Ingredients | | | Purified Water | |

| Other Ingredients (Human Only) | Natural French Vanilla, Orange Flavor, |
|---|---|
| | & Lo Han (Siraitia grosvenorii) |

### Other Ingredients: Purified Water

Other Ingredients (Human Only): Natural French Vanilla, Orange Flavor, & Lo Han (Siraitia grosvenorii)

### Example 5: Remove Table

| | Grams | | | wt.% of total |
|---|---|---|---|---|
| Ingredient | 2 oz | 1 oz | Description | weight of formulation |
| Zeolite | 1.900 | 0.950 | Clinoptilolite Zeolite-Purified | 95.0000% |
| Shilajit | 0.100 | 0.050 | Shilajit-Trace Minerals | 5.0000% |
| Other Ingredients | 0.000 | 0.000 | Fruit Source Citric Acid | 0.0000% |
| Totals | 2.000 | 1.000 | | 100.00% |
| Other Ingredients | | | Purified Water | |
| Shilajit-optional | | | | |

### Example 6

| | | | | wt.% of total |
|---|---|---|---|---|
| | Grams | | | weight of |
| Ingredient | 2 oz | 1 oz | Description | formulation |
| Zeolite | 0.125 | 0.063 | Clinoptilolite Zeolite from Zeo Health | 6.2500% |
| Glucosamine Sulfate | 0.200 | 0.100 | From Shell Fish | 10.0000% |
| Chondroitin Sulfate | 0.200 | 0.100 | From Bovine source | 10.0000% |
| Turmeric | 0.250 | 0.125 | 95% Curcuminoids | 12.5000% |
| Guggul | 0.250 | 0.125 | Commiphora mukul 10% Guggulipids | 12.5000% |
| Camu Camu | 0.125 | 0.063 | 20% Vitamin C | 6.2500% |
| Collagen Concentrate | 0.350 | 0.175 | Green-Lipped Mussel | 17.5000% |
| Boswellia serrata | 0.500 | 0.250 | 65% Boswellic acids | 25.0000% |
| Other Ingredients | 0.000 | 0.000 | Fruit Source Citric Acid | 0.0000% |
| Totals | 2.000 | 1.000 | | 100.00% |
| Other Ingredients | | | Purified Water | |

| | |
|---|---|
| Other Ingredients (Human Only) | Natural French Vanilla, Orange Flavor, |
| | & Lo Han (Siraitia grosvenor |

### Example 7

| | | | wt.% of total |
|---|---|---|---|
| Ingredient | Grams | Description | weight of formulation |
| Whey Protein | 260.00 | 80% Agglomerated instantized grass | 57.1931% |
| | | fed proserum wisdom proteins | |
| Amino Blend | 1.00 | | 0.2200% |
| Immunel | 1.00 | Sterling Technology Brand “Immunel” | 0.2200% |
| Vanilla/Chocolate Powder | 40.00 | Organic soluble Vanilla/Chocolate 4 | 8.7989% |
| | | fold vanilla, coconut, cinnamon | |
| Bovine Source Collage | 5.00 | Bovine source hydrolyzed collagen powder | 1.0999% |
| MCT Oil | 3.00 | Medium-chain Triglyceride Organic | 0.6599% |
| Enzymes Blend | 1.00 | | 0.2200% |
| Probiotics Blend | 1.00 | | 0.2200% |
| Mushrooms Blend | 1.00 | Shitake, Mitake, Cordyceps, Reishi | 0.2200% |
| Ashwagandha | 5.00 | 1.5% withanolides | 1.0999% |
| Lions Mane Mushroom | 5.00 | Exact if possible | 1.0999% |
| Mucuna pruriens | 4.00 | Seed-Use extract 25% L-Dopa | 0.8799% |
| Moringa | 10.00 | Organic Moringa | 2.1997% |
| Purselane Blend | 5.00 | | 1.0999% |
| Udderly Oats Blend | 44.00 | | 9.6788% |
| Super Greens-Fruit | 50.00 | | 10.9987% |
| Mineral Blend | 1.00 | | 0.2200% |
| Tribulus Terrestris | 2.00 | 45% Saponins-for steroid-like effects | 0.4400% |
| Tongkat Ali | 2.00 | Muscle mass and potency | 0.4400% |
| Fadogia Agrestis | 2.00 | Supports increase of muscle mass | 0.4400% |
| Shilajit | 1.00 | Minerals | 0.2200% |
| Lecithin Powder | 5.00 | Sunflower Lecithin-Organic | 1.0999% |
| Monk Fruit Extract | 0.60 | 80% Mogrosides | 0.1320% |
| Wild Blueberry | 5.00 | 50 milligrams of Gallic Acid | 1.0999% |
| Totals | 454.600 | | 100.0000% |

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A micronized composition for improving healthy diets, immune systems, and/or joint health of one or more subjects, the micronized composition comprises:
a first micronized blend of transfer factor materials comprising cow or bovine colostrum and/or derived from at least one cow colostrum extract and free of egg yolk(s);
a second micronized blend of organic mushrooms; and
micronized gallic acid derived from at least one natural food source,
wherein micronized particles of the first micronized blend, the second micronized blend, and the micronized gallic acid have average particle diameters of less than about 8 microns.

2. The micronized composition of claim 1, wherein the average particle diameters are less than about 5 microns.

3. The micronized composition of claim 1, wherein the first micronized blend of transfer factor materials is present at a concentration from about 0.1 wt. % to about 35 wt. %, calculated to a total weight of the micronized composition.

4. The micronized composition of claim 3, wherein the first micronized blend, the second micronized blend, and the micronized gallic acid are present at a ratio from about 1:1:5 to about 20:5:1.

5. The micronized composition of claim 3, wherein the first micronized blend, the second micronized blend, and the micronized gallic acid are present at a ratio of about 1:1:5 or 20:5:1.

6. The micronized composition of claim 3, further comprising at least one selected from whey protein, a third micronized blend of amino acids, micronized quercetin, and a combination thereof.

7. The micronized composition of claim 6, wherein the whey protein is present at a concentration of greater than about 55 wt. %, calculated to the total weight of the micronized composition.

8. The micronized composition of claim 6, wherein, when present in the micronized composition, micronized particles of the third micronized blend and/or the micronized quercetin have average particle diameters of less than about 10 microns.

9. The micronized composition of claim 1, wherein the micronized gallic acid is derived from wild blueberries.

10. The micronized composition of claim 1, further comprising micronized particles of quercetin having average particle diameters of less than about 10 microns.

11. The micronized composition of claim 10, wherein the micronized particles of quercetin are present at a concentration from about 15 wt. % to about 25 wt. %, calculated to a total weight of the micronized composition.

12. A method for producing at least one micronized composition for improving healthy diets, immune systems, and/or joint health of one or more subjects, the method comprising:
micronizing composition ingredients by at least one micronization process to produce a first micronized blend of transfer factor materials, a second micronized blend of organic mushrooms, and micronized gallic acid; and
mixing the first micronized blend, the second micronized blend, and the micronized gallic acid together to product a micronized composition,
wherein
the first micronized blend comprises cow or bovine colostrum and/or is derived from at least one cow colostrum extract and is free of egg yolk(s),
micronized particles of the first micronized blend, the second micronized blend, and the micronized gallic acid have average particle diameters of less than about 10 microns, and
the first micronized blend is present at a concentration from about 0.1 wt. % to about 35 wt. %, calculated to a total weight of the micronized composition.

13. The method of claim 12, further comprising:
micronizing quercetin to produce micronized quercetin; and
adding the micronized quercetin to the micronized composition,
wherein micronized particles of the micronized quercetin have average particle diameters of less than about 10 microns.

14. The method of claim 13, wherein micronized particles of quercetin are present at a concentration from about 15 wt. % to about 25 wt. %, calculated to the total weight of the micronized composition.

15. The method of claim 12, further comprising:
micronizing amino acids to produce a third micronized blend of amino acids; and
adding the third micronized blend to the micronized composition,
wherein micronized particles of the third micronized blend have average particle diameters of less than about 10 microns.

16. The method of claim 12, further comprising:
mixing whey protein into the micronized composition, wherein the whey protein is present at a concentration of greater than about 55 wt. %, calculated to the total weight of the micronized composition.

17. The method of claim 12, wherein the at least one micronization process comprises a jet milling process and the micronized particles have average particle diameters of less than about 5 microns.

18. A kit comprising:
the micronized composition of claim 1; and
at least one delivery system configured to facilitate delivery of the micronized composition to at least one subject.

19. The kit of claim 18, wherein the at least one delivery system consists of a liquid delivery system, a solid delivery system, or a combination thereof.

20. The kit of claim 18, wherein the at least one delivery system comprises at least one selected from the group consisting of at least one pipette, at least one scooping device, and a combination thereof.
